(19) United States
(12) Patent Application Publication
(10) Pub. No.: US 2011/0010093 A1
(43) Pub. Date: Jan. 13, 2011

(54) METHOD FOR ENCOURAGING LOCATION AND ACTIVITY LABELING

(75) Inventors: Kurt E. Partridge, Palo Alto, CA (US); Maurice K. Chu, Burlingame, CA (US); Philipp L. Bolliger, Winterthur (CH)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/500,377

(22) Filed: Jul. 9, 2009

(51) Int. Cl. G01S 3/02; G06F 1/32; G06F 15/00; G06N 5/04

(52) U.S. Cl. 701/300; 342/451; 713/323; 702/150; 706/46

(57) ABSTRACT

One embodiment of the present invention provides a system for location labeling. During operation, the system collects contextual information recorded by one or more components located on a computing device associated with a user, and determines whether the computing device is stationary based on collected information. Responsive to the computing device being stationary, the system allows the user to provide a location label.

### BACKGROUND

1. Field

This disclosure is generally related to inference of a user's indoor location. More specifically, this disclosure is related to a method that encourages a user to provide location labels.

2. Related Art

Activity modeling is becoming increasingly important because it enables many new applications, such as environmental pollutant production monitoring, health monitoring, automatic status updates to friend, timing coordination, power management, and interstitial media delivery. It also shows promise for many more applications that benefit from accurate user models, such as helping people understand how they spend their time, providing ethnographers with more data to help them better understand human behaviors, and supplying epidemiologists with information that helps them understand the relationship between behavior and health.

In order to model a person's activities, it is important to track his locations, even in an indoor environment. The proliferation of mobile devices and their increasing computation capabilities have made it possible to track the locations of users of such devices. For example, many mobile devices are equipped with Global Positioning System (GPS) receivers which can be used for location tracking. However, GPS signals do not reliably penetrate building walls, and even if they do, signal reflections produce errors, thus making room-level indoor location sensing difficult to accomplish using GPS alone. Although such room-level location sensing can be feasible with additional hardware infrastructures, installations of such infrastructures are typically too expensive to be justified for many places.

On the other hand, one popular approach of indoor positioning is to use existing WiFi signals in an indoor environment to infer location. Because WiFi signals, like other radio signals, weaken when travelling away from the source, a WiFi receiver that also measures signal strength can be used to provide location information. However, WiFi signal strength values do not map reliably to physical locations. Due to the fact that WiFi signals often reflect off various objects, such as walls, people, and other antennas, their strengths do not decrease in a predictable way as the distance between the transmitter and the receiver increases. However, if there are enough transmitters, (for example six or more), then the combined signal strength readings can provide a fairly unique “fingerprint” that can be used to identify a room.

The difficulty of implementing such a room-level positioning system is to determine the mapping between WiFi fingerprints and rooms beforehand. One approach is to perform calculations with detailed models of the environment and the other one is to collect a dense dataset of WiFi fingerprints and their associated true locations. The first approach is less accurate and requires additional information (such as building floor plans) that is not always available and easy to input. The latter approach is tedious and time-consuming because signal readings must be collected every few meters or so, with pauses of tens of seconds at each position to get an accurate reading. Moreover, an accurate mapping also requires the readings to be taken for different orientations at each location. Even so, the mapping can still be inaccurate because of unpredictable time-varying signal characteristics. For example, people may move in and out of a room, or furniture may be rearranged, thus changing signal reflection pattern. Another complication of this approach is that the collection of WiFi fingerprints has to be repeated frequently because infrastructure or environment may change over time. For example, access points may be moved, removed, or added. What is needed is a method and apparatus that can provide an accurate mapping of indoor locations without the aforementioned problems.

### SUMMARY

One embodiment of the present invention provides a system for location labeling. During operation, the system collects contextual information recorded by one or more components located on a computing device associated with a user, and determines whether the computing device is stationary based on collected information. Responsive to the computing device being stationary, the system allows the user to provide a location label.

In a variation on this embodiment, the system determines a time period during which the computing device is stationary, and applies a single location label to all contextual information collected over the time period.

In a variation on this embodiment, the system determines whether the computing device is currently located at a predetermined location.

In a variation on this embodiment, the system allows the user to provide a location label for a place that the user has visited previously.

In a further variation, the system determines a time period during which the computing device is stationary at the previously visited place.

In a variation on this embodiment, the one or more components include at least one of: a WiFi receiver, an accelerometer, a clock, and a calendar.

In a variation on this embodiment, the computing device is a laptop computer configured to delay a standby and/or a hibernation process for a predetermined amount of time after the laptop computer's lid is closed.

In a variation on this embodiment, the computing device is a mobile device.

### BRIEF DESCRIPTION OF THE FIGURES

FIG. 1 provides a diagram illustrating a partial floor plan of a building.

FIG. 2 presents a diagram illustrating WiFi signal patterns recorded by three laptop computers at three different locations within a building in accordance with an embodiment of the present invention.

FIG. 3 presents a block diagram illustrating an exemplary architecture of a computing device in accordance with an embodiment of the present invention.

FIG. 4 presents a diagram illustrating an exemplary motion magnitude trace of a user in accordance with an embodiment of the present invention.

FIG. 5 presents a diagram illustrating an example of interval labeling in accordance with an embodiment of the present invention.

FIG. 6A presents a diagram illustrating an exemplary GUI for location labeling in accordance with an embodiment of the present invention.

FIG. 6B presents a diagram illustrating an exemplary GUI for a user to enter a current location in accordance with an embodiment of the present invention.

FIG. 7 presents a flowchart illustrating the process of obtaining a location label from a user in accordance with an embodiment of the present invention.

FIG. 8 illustrates an exemplary computer system for inferring employment in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system for obtaining location labels from a user. The system obtains contextual data collected by a number of sensor components located on a computing device associated with the user. Based on the contextual data, the system determines whether the computing device, thus the user, is stationary. If so, the system allows the user to provide a location label, either for a current location or for a previous location. In addition, the system applies the location label to all data collected during a time period that the computing device is stationary.

### Location Labeling

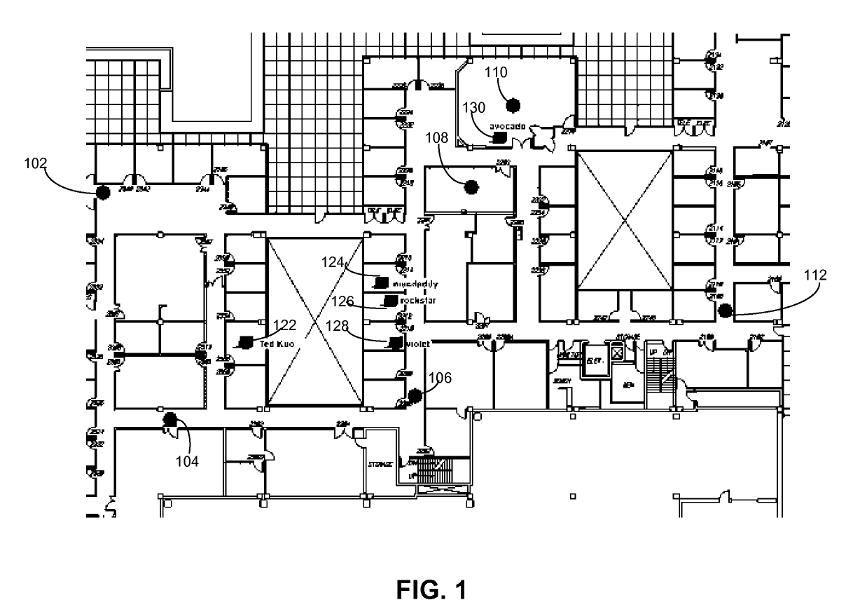

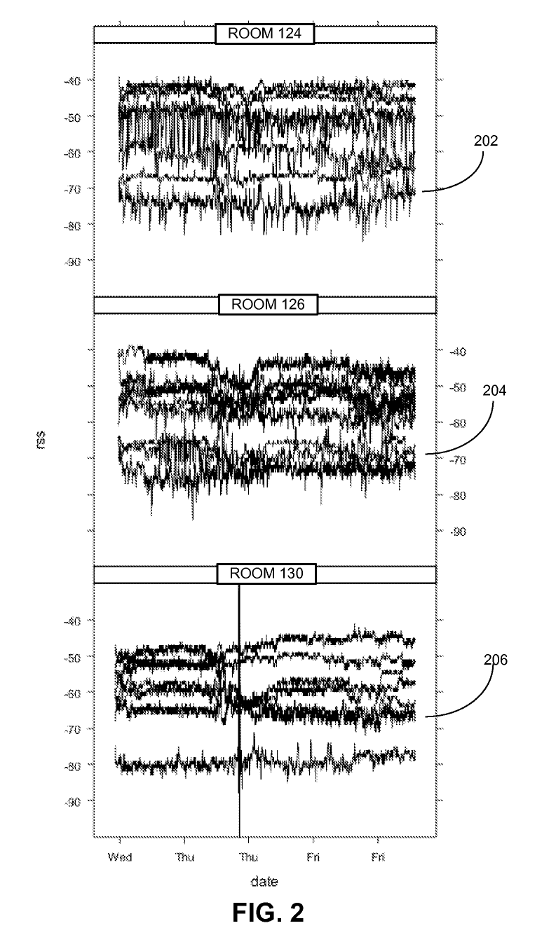

FIG. 1 provides a diagram illustrating a partial floor plan of a building. Building 100 includes a number of rooms and a number of WiFi access points, such as access points 102-112. A number of computing devices, such as laptop computers 122-130 are located in different rooms of building 100. Due to the current distribution pattern of access points, each laptop can record a unique WiFi signal pattern. FIG. 2 presents a diagram illustrating WiFi signal patterns recorded by three laptop computers at three different locations within building 100. The vertical axis measures the received signal strength (RSS), and the horizontal axis measures the days of week. Different lines correspond to the RSSs from different access points, each having a unique BSSID (basic service set identifier). Patterns 202, 204, and 206 are recorded by laptops located at room 124, 126, and 130, respectively. As illustrated in FIG. 1, rooms 124 and 126 are adjacent to each other, and room 130 is farther away. Note that room 124 and 126's patterns (patterns 202 and 204) resemble each other much more than either of them to room 130's pattern (pattern 206), indicating how RSS readings can be used to determine positions.

RSS patterns 202-206 suggest both short-term signal strength variation from minute-to-minute and long-term fluctuation. The short-term variation may be caused by movement of people and other environmental factors. The long-term variance, which is especially noticeable in pattern 204, shows that for nearby locations a one-time calibration may not be sufficient. One way to cope with the long-term variance is to update the WiFi fingerprint-location map frequently by taking measurements at different times of the day and days of the week. RSS patterns shown in FIG. 2 also suggest that one way to reduce the error caused by short-term signal variance is to average a large number of measurements taken during a short time.

Instead of hiring professionals to perform the calibration operation, in one embodiment, the system relies on computing device users to provide location labels while the system is taking a measurement. As long as the system is able to query the user for a new location label when the system is unsure about how to associate a signal reading with a location, the system can eventually obtain a detailed WiFi fingerprint-location map. However, such an approach may cause unwanted interruptions to users, especially when the system requires repeated measurements. In addition, the system can only associate one location label with readings taken at the moment, thus not able to address the short-term variance.

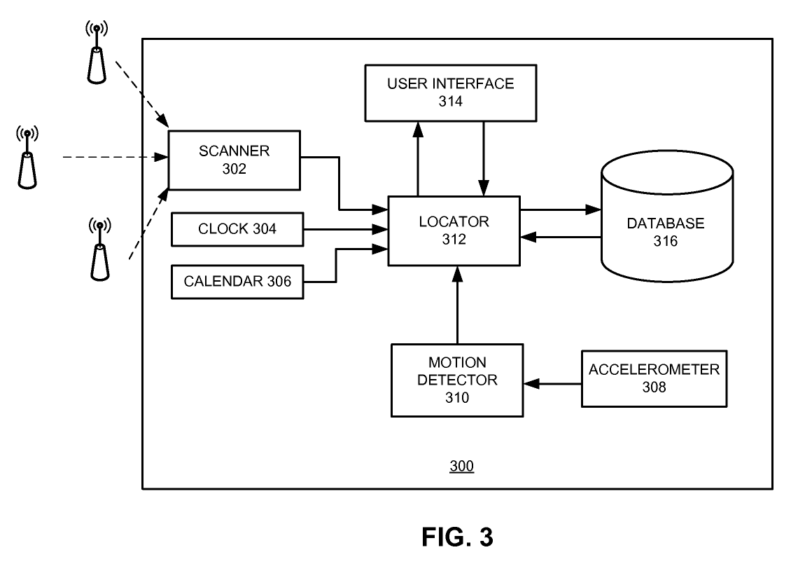

To overcome such problems, in one embodiment of the present invention, the system not only takes WiFi signal measurements, but also collects other contextual data using various sensor components located on the computing device. FIG. 3 presents a block diagram illustrating an exemplary architecture of a computing device in accordance with an embodiment of the present invention. Computing device 300 can be any portable electronic devices with computational capability. Examples of mobile computing device 300 include, but are not limited to: a laptop computer, a mobile phone, a personal digital assistant (PDA), and a game console. In some embodiments, mobile computing device 300 can be a wearable computing device that is integrated into a piece of clothing or an accessory that can be worn by a user. For example, a wearable device can be sewn into a shirt or a hat. In addition, a wearable device can be part of a pair of glasses, a watch, or pieces of jewelries

Computing device 300 includes a number of sensor components and applications, such as a scanner 302, a clock 304, a calendar 306, and an accelerometer 308. In addition, computing device 300 includes a motion detector 310, a locator 312, a user interface 314, and a database 316. Scanner 302 receives and measures the strengths of WiFi signals, and sends the measurements to locator 312, which estimates the location of the device using a WiFi fingerprints-location map stored in database 318. Clock 304 can provide timing information. Calendar 306 can provide information regarding the user's scheduled appointments. Note that, in addition to mobile phones which are often equipped with accelerometers, nowadays laptop computers also contain accelerometers. Accelerometers on laptops are initially designed to be used to detect when a laptop has been dropped and is soon likely to contact a hard surface. By detecting the fall in time, the system can park the hard drive head to prevent damages to the hard drive. In some embodiments of the present invention, the accelerometer data is used for determining the movement of computing device 300.

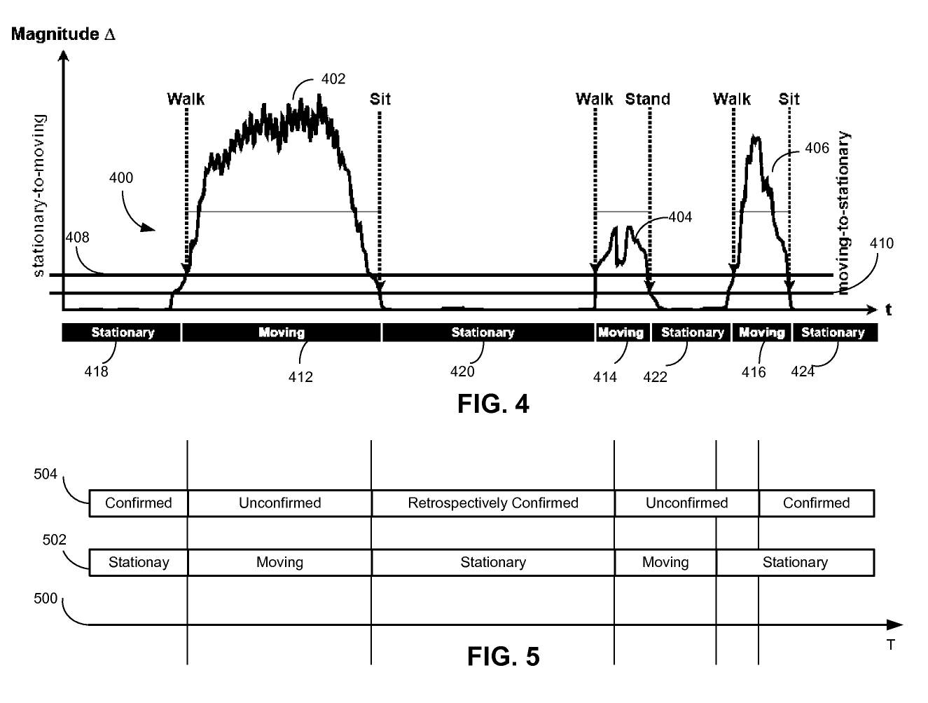

Motion detector 310 is a discrete classifier that reads data from accelerometer 308 to determine whether computing device 300 is moving or stationary. Classification needs to be somewhat forgiving so minor movements and vibrations caused by readjusting the screen or moving the laptop from a desk to the user's lap can still be classified as “stationary.” Only significant motion such as walking or running should be classified as “moving.” To classify the motion state of device 300, in one embodiment, motion detector 310 samples all three accelerometer axes at a certain frequency, for example 5 Hz, and then calculates the acceleration magnitude and subtracts it from the previously sampled magnitude. In a further embodiment, to prevent the misclassification of small movements as “moving,” the sampled signal is smoothened into a moving average of the last 20 values. FIG. 4 presents a diagram illustrating an exemplary motion magnitude trace of a user in accordance with an embodiment of the present invention. In the example shown in FIG. 4, a user goes from his office to his colleague's office and comes back. On his way back, he stopped shortly in the hallway to chat with another colleague. Because he is carrying his laptop computer with him all the time, his movement pattern can be extracted from accelerometer data recorded by the laptop. FIG. 4 illustrates a motion magnitude trace 400. A number of sections of trace 400 demonstrate significantly increased magnitude values, such as sections 402, 404, and 406. The system can determine whether the motion magnitude value at a certain moment exceeds a threshold, and if so, the system can classify such a moment as “moving.” In FIG. 4, time intervals correspond to sections 402, 404, and 406 are classified as “moving” as indicated by sequence bars 412, 414, and 416, respectively. Note that these sequence bars are the output of motion detector 310. In FIG. 4, the output of motion detector 310 also includes a number of stationary intervals indicated by sequence bars 418-424. In the example shown in FIG. 4, sequence bars 412-424 correspond to the user's movement sequence as staying in his office (sequence 418), walking to the colleague's office (sequence 412), staying in the colleague's office for a lengthy discussion (sequence 420), walking back (sequence 414), standing in the hallway to have a brief discussion with another colleague (sequence 422), walking back (sequence 416), and staying in his office again (sequence 424). FIG. 4 also demonstrates that the classifier includes hysteresis with different threshold values when switching between the moving and stationary states. For example, a switch from a stationary state to a moving state is determined by a threshold 408, whereas a switch from a moving state to a stationary state is determined by a threshold 410. The exact threshold values can be established from experimental data. Note that compared with the classification of stationarity for a laptop computer, the algorithm for classifying stationarity of a mobile phone may be more forgiving because a user carrying the mobile phone may fidget.

By detecting computing device 300 being stationary or moving, the system is able to use an interval labeling technique which applies a location label not only to an immediate signal strength measurement, but also to all measurements taken during the interval while the device was stationary, at the same location. FIG. 5 presents a diagram illustrating an example of interval labeling in accordance with an embodiment of the present invention. FIG. 5 illustrates a time axis 500 indicating the increasing of time. In FIG. 5, based on the output of motion detector 310, the system partitions time along a time axis 500 into alternating periods of “moving” and “stationary” as indicated by row 502. Whenever the device is stationary, the system continues to record signal strengths during the interval, and when the device is moving, the system stops taking measurements until the device rests again, at which time a new interval begins. The location of the computing device during stationary intervals can be confirmed by user input, either instantly or retrospectively, as indicated by row 504. In addition to increasing the number of WiFi measurements that can be associated with a location label, thus eliminating short-term variation, interval labeling can also improve the user's experience of providing labels. Because intervals are known to be periods of immobility, they can be more easily labeled asynchronously. A user is more likely to remember their location during the entire interval (knowing its staring time, ending time, and duration) than they are likely to remember their location at a specific instant. Consequently, the system can postpone labeling until a more convenient time such as the start of the next stationary period, or when the user returns to his desk. This approach can reduce the obtrusiveness of any explicit location query. Row 504 marks whether the location of each time interval has been confirmed by the user (location label provided).

If motion detector 310 detects that computing device 300 is stationary, the system can imply that computing device 300 stays at the same location for the time being. Consequently, user interface 314 can query the user to receive a location label. Because a user is more likely to label places he spends a large amount of time in, such as his office, stationarity detection can significantly increase the number of labeled data without adding extra burden to the user. In one embodiment, user interface 314 queries the user for a location label once the system determines that computing device 300 has been stationary for a while, such as five minutes or more. Moreover, because it has been determined that computing device 300 stays at the same location, locator 312 can apply the obtained location label to all data collected during the time period that computing device 300 stays stationary. This is an improvement over the previous approach in which the system can only associate a location label with data collected at the moment the user is queried. In some embodiments, user interface 314 is located on a different computing device other than computing device 300. For example, computing device 300 can be a mobile phone and user interface 314 may be located on a desktop computer associated with the user. During operation, computing device (mobile phone) 300 transmits sensor data to a server, which in turn provides such data to an application running on the desktop computer. Once it is determined that computing device 300 is stationary, user interface 314 located on the desktop computer can query the user for location labels.

In addition to detecting stationarity, motion detector 310 can also detect when the user is walking and the number of steps taken by the user, based on accelerometer traces. In one embodiment, motion detector 310 can detect a distance between two significant places based on accelerometer traces. For example, a user may leave his office to attend meetings in a conference room, and the distance between his office and the conference room can be determined based on the number of steps he takes. Overtime, the system can obtain a labeled graph of locations and distances between locations. Such a graph can be used to reduce latency and increase accuracy of the indoor positioning system. Also note that because a laptop computer tends to automatically go into hibernation or go to a standby mode once its lid is shut making recording accelerometer data impossible, the system may modify the laptop's sleep sequence to keep it awake even after its lid is shut. Consequently, the laptop can continue to record accelerometer data after a user close the lid of his computer and walks to a different location. For practical reason, the system can allow the laptop computer to hibernate or sleep after a predetermined time period, such as five or ten minutes, depending on the typical distances that the user walks during the day. In one embodiment, the system learns such distances over time and adjusts a timer that controls the sleep sequence accordingly.

In one embodiment, the system can establish a “common place” of a user. A “common place” is a place that a user stays for long periods of time routinely, such as his office or his home desk. Once the user has labeled such a common place, the system can determine when a user returns to the common place based on WiFi signal strengths or a combination of WiFi signal strengths and other sensor data. In one embodiment, the system determines that computing device 300 resides at the common place based on measured WiFi signal strengths and the fact that the power cord of computing device 300 is plugged in.

Compared to other places, a user is more relaxed and more likely to provide location labels at his common place. For example, when a user is out and about around the office building, such as attending meetings, he is concentrating on his current task and cannot respond to the location query. However, once he returns to the common place, such as his office, the user is likely not to be involved with anything that requires immediate attention, thus being capable of responding to location queries. In one embodiment, once locator 312 detects that computing device 300 returns to the common place, user interface 314 queries the user for previous places and activities. To help a user to correctly label a previous location, in one embodiment, the system extracts timing information in relation to the user's stay at a location, including the beginning and ending time, or the duration of his stay. For example, after a 30-minute meeting, a user returns to his office at 3 PM. Once the system determines that the user is at his office, the system queries the user for a previous place at which he spent about 30 minutes, or the system may query the user for the location at which he was stable between 2:25 PM and 2:55 PM. Because it is possible for a user to make many short stays that are less significant and less memorable (for example, a user may chat briefly with a colleague in the hallway), in one embodiment, the system may filter stable periods to make sure that a user is only queried about stays that last for a significant amount of time, such as five minutes or more.

In one embodiment user interface 314 queries the user for more than one location that he has been stable prior to his return to the common place. For example, once a user returns to his office, the system may ask the user to label: a most recent location at which he was stable for 30 minutes, a location prior to the most recent one at which he was stable for an hour, and an even earlier location at which he was stable for 15 minutes. With his memory still fresh, the user is likely able to provide location labels to all these places.

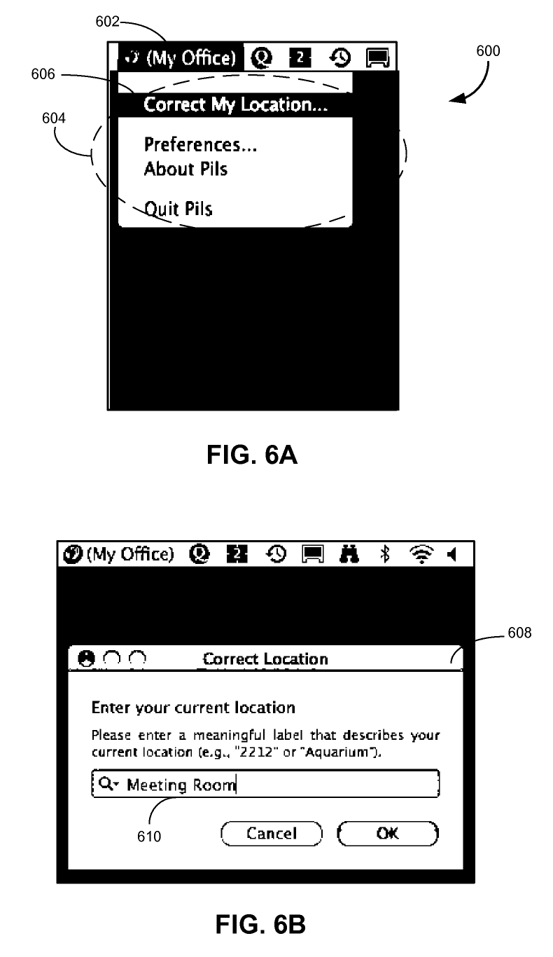

In one embodiment, the system presents the user with a graphic user interface (GUI) for inputting location label. FIG. 6A presents a diagram illustrating an exemplary GUI for location labeling in accordance with an embodiment of the present invention. In FIG. 6A, GUI 600 includes a tab 602 which indicates the system's guess for a current location based on readings of WiFi signal strengths and/or other sensor data. In the example shown in FIG. 6A, tab 602 indicates the current location as “My Office.” If the system's guess is wrong, the user can manually input his current location by clicking on tab 602 to show a drop down menu 604, and by selecting an item 606 indicating “Correcting My Locations” within drop down menu 604. FIG. 6B presents a diagram illustrating an exemplary GUI for a user to enter a current location in accordance with an embodiment of the present invention. FIG. 6B includes a window 608, which includes a text message prompting the user to enter a label describing his current location in a field 610. For example, in FIG. 6B, a location label showing “Meeting Room” is entered into field 610. Note that in order to maintain labeling consistency, in one embodiment, the system provides auto-completion when the user is entering a location label, thus preventing the user from entering new synonyms for the same location.

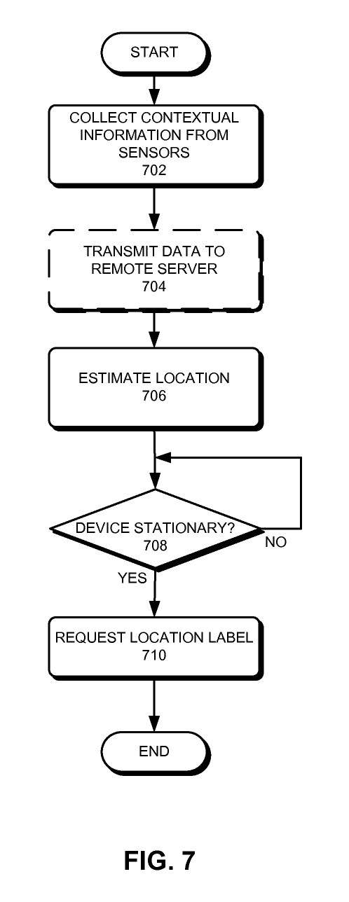

FIG. 7 presents a flowchart illustrating the process of obtaining a location label from a user in accordance with an embodiment of the present invention. During operation, the system collects contextual information from a number of sensors located on a computing device associated with the user (operation 702). Examples of contextual information include, but are not limited to: received WiFi signal strengths, accelerometer traces, clock information, and calendar entries. If the computing device is a low-power device or a device with limited computational capacity, the system can optionally transmit the collected data to a remote server for processing (operation 704). The system estimates a location based on collected contextual information and/or a stored WiFi signal-location mapping (operation 706). For example, based on a user's calendar entry of a meeting and a current time, the system can determine that the user's current location is the corresponding meeting room. Alternatively, the system can estimate a user's location based on the mapping between received WiFi signal pattern and a corresponding location. The system also determines whether the computing device is stationary based on the accelerometer trace (operation 708). If so, the system queries the user for a location label (operation 710). Note that in addition to query the user for a current location, the system may also query the user for one or more of past locations.

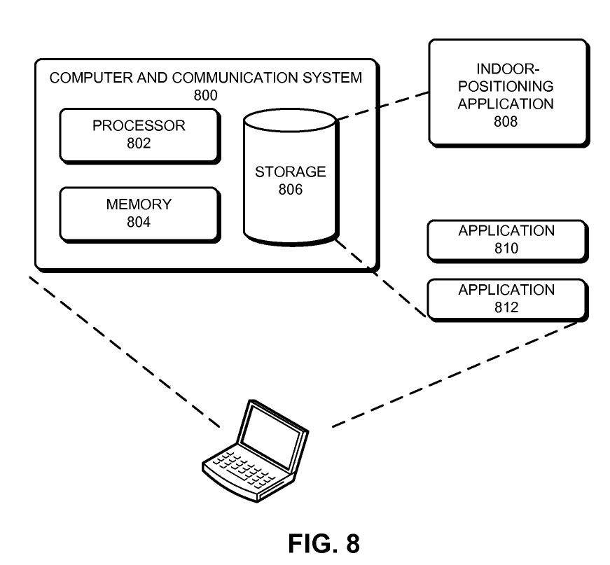

FIG. 8 illustrates an exemplary computer system for inferring employment in accordance with one embodiment of the present invention. In one embodiment, a computer and communication system 800 includes a processor 802, a memory 804, and a storage device 806. Storage device 806 stores an indoor-positioning application 808, as well as other applications, such as applications 810 and 812. In one embodiment, indoor-positioning application 808 further includes a program that facilitates location labeling using one or more of the aforementioned methods. During operation, indoor-positioning application 808 is loaded from storage device 806 into memory 804 and then executed by processor 802. While executing the program, processor 802 performs the aforementioned functions.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for location labeling, the method comprising:
collecting contextual information recorded by one or more components located on a computing device associated with a user;
determining whether the computing device is stationary based on collected information; and
responsive to the computing device being stationary, allowing the user to provide a location label.

2. The method of claim 1, further comprising determining a time period during which the computing device is stationary, and applying a single location label to contextual information collected over the time period.

3. The method of claim 1, further comprising determining whether the computing device is currently located at a predetermined location.

4. The method of claim 1, further comprising allowing the user to provide a location label for a place that the user has visited previously.

5. The method of claim 4, further comprising determining a time period during which the computing device is stationary at the previously visited place.

6. The method of claim 1, wherein the one or more components comprise at least one of:
a WiFi receiver;
an accelerometer;
a clock; and
a calendar.

7. The method of claim 1, wherein the computing device is a laptop computer, and wherein the laptop computer is configured to delay a standby and/or a hibernation process for a predetermined amount of time after the laptop computer's lid is closed.

8. The method of claim 1, wherein the computing device is a mobile device.

9. A system for location labeling, comprising:
one or more sensors located on a computing device associated with a user for collecting contextual information;
a motion detector configured to detect whether the computing device is stationary based on the collected contextual information; and
a user interface configured to allow the user to provide a location label in response to the computing device being stationary.

10. The system of claim 9, wherein the motion detector is further configured to detect a time period during which the computing device is stationary, and wherein a single location label is applied to contextual information collected over the time period.

11. The system of claim 9, further comprising a locator configured to determine whether the computing device is currently located at a predetermined location.

12. The system of claim 9, wherein the user interface is further configured to allow the user to provide a location label for a place that the user has visited previously.

13. The system of claim 12, wherein the motion detector is further configured to detect a time period during which the computing device is stationary at the previously visited place.

14. The system of claim 9, wherein the one or more components comprise at least one of:
a WiFi receiver
an accelerometer;
a clock; and
a calendar.

15. The system of claim 9, wherein the computing device is a laptop computer, and wherein the laptop computer is configured to delay a standby and/or a hibernation process for a predetermined amount of time after the laptop computer's lid is closed.

16. The system of claim 9, wherein the computing device is a mobile device.

17. A computer-readable storage medium storing instructions that when executed by a computer cause the computer to perform a method for location labeling, the method comprising:
collecting contextual information recorded by one or more components located on a computing device associated with a user;
determining whether the computing device is stationary based on collected information; and
responsive to the computing device being stationary, allowing the user to provide a location label.

18. The computer-readable storage medium of claim 17, wherein the method further comprises determining a time period during which the computing device is stationary, and applying a single location label to all contextual information collected over the time period.

19. The computer-readable storage medium of claim 17, wherein the method further comprises determining whether the computing device is currently located at a predetermined location

20. The computer-readable storage medium of claim 17, wherein the method further comprises allowing the user to provide a location label for a place that the user has visited previously.

21. The computer-readable storage medium of claim 20, wherein the method further comprises determining a time period during which the computing device is stationary at the previously visited place.

22. The computer-readable storage medium of claim 17, wherein the one or more components comprise at least one of:
a WiFi receiver;
an accelerometer;
a clock; and
a calendar.

23. The computer-readable storage medium of claim 17, wherein the computing device is a laptop computer, and wherein the laptop computer is configured to delay a standby and/or a hibernation process for a predetermined amount of time after the laptop computer's lid is closed.

24. The computer-readable storage medium of claim 17, wherein the computing device is a mobile device.
